(19) United States
(12) Patent Application Publication
(10) Pub. No.: US 2017/0368718 A1
(43) Pub. Date: Dec. 28, 2017

(54) Apparatus for Impregnating a Porous Medium Comprising Optimized Coated Electrodes

(71) Applicant: FIBROLINE, Ecully (FR)

(72) Inventor: Joric Marduel, Chazay D'azergues (FR)

(21) Appl. No.: 15/533,624

(22) PCT Filed: Dec. 8, 2015
(86) PCT No.: PCT/FR2015/053379

§ 371 Date: Jun. 6, 2017

(30) Foreign Application Priority Data
Dec. 9, 2014 (FR) 1462137

(51) Int. Cl. B29B 15/12

(52) U.S. Cl. CPC B29B 15/12

(57) ABSTRACT

Apparatus for impregnating a porous medium with powder, including a device able to generate an alternating electric field through the porous medium, the device including a first electrode and a second electrode, which are placed on either side of the porous medium, the apparatus being characterized in that: the first electrode is covered with a screen making contact with the electrode, said screen having a dielectric strength higher than 6 kV/mm; and the second electrode is covered with a protective layer, said protective layer having a superficial resistivity higher than 1×10¹²Ω/□.

### FIELD OF TECHNOLOGY

The present disclosure relates to an apparatus for impregnating a porous medium with powder, by applying an electric field. It more particularly relates to an apparatus making it possible to impregnate a porous medium, for example a nonwoven or woven, paper, or even open-cell foam.

### BACKGROUND

Different types of methods are known in the prior art for impregnating a porous medium with powder. They make it possible to functionalize the medium depending on its use. Examples include impregnating a textile with hydrophobic powder making it possible to produce more impermeable clothing, or impregnating a needled nonwoven mat with a powder of the thermal bonding type, so as to promote the cohesion of its component fibers after an appropriate heat treatment of the mat. Of course, impregnating techniques are used in many other technical fields such as automobiles, health, the environment, etc.

Document WO 99/22920 describes an example apparatus for impregnating a porous medium, by applying an alternating electric field. The apparatus comprises two metal plates positioned facing one another, so as to form a passage for the porous medium. The latter has previously been sprinkled with powder before passing between the plates. A voltage generator is connected to the plates so as to generate an alternating electric field between said plates to allow the powder to move between the system's electrodes and, if applicable, in the medium. The surfaces of the facing plates are covered with a glass screen in order to prevent electric arcs from forming between the electrodes. Quickly after starting the apparatus, the abrupt appearance of rupture points was noticed in the screens, causing breakdown or dielectric breakdown thereof. It is then necessary to change the glass screens relatively often to prevent this breakdown phenomenon. This frequency is even higher when the amplitude of the electric field between the metal plates is high.

To slow this aging phenomenon and therefore decrease operations on the apparatus, document FR 2,933,327 proposes to replace each metal plate with conductive strips, arranged successively and separated by air knives. It has been observed that the glass screens deteriorate more slowly for identical usage conditions. This improved resistance to aging appears to be related to the smaller electric stress exerted by the electric arcs on the glass screens. In return, the electric field is less intense at the surfaces of the glass screens not covered with the conductive strips. As a result, the electric field between the glass screens is not homogeneous. It is then necessary to extend the length of the electrodes to compensate for this lack of homogeneity and/or to reduce the passage speed of a porous medium between the glass screens to obtain impregnation of a powder in said medium, comparable to an impregnation obtained under the same conditions with an apparatus described above.

Some porous mediums have a critical electric conductivity and/or a high relative humidity, for example textiles with a base of natural or cellulosic fibers. They then require the use of electric fields with a higher amplitude to counter the attenuation of the electric field in this type of material.

### SUMMARY OF THE DISCLOSURE

The Applicant has observed that as a result, the lack of homogeneity of the electric field between the electrodes and the breakdown phenomenon of the glass screens mentioned above are greater, in particular under high humidity.

In other words, it appears that the increased humidity is detrimental to the good quality, and in particular the homogeneity, of the electric field between the electrodes. This application aims to propose an apparatus for impregnating a porous medium with powder, having better resistance to aging and allowing the formation of a more homogeneous electric field to promote more regular impregnation of the powder in the porous medium.

The disclosed impregnating apparatus makes it possible to resolve the aforementioned technical problems when the electric field has a high amplitude, and more particularly when this amplitude reaches a level allowing the ionization of the air or a gas present between the electrodes, visible in the form of a plasma.

To that end, the apparatus comprises a device able to generate an alternating electric field through a porous medium, the device including at least a first electrode and a second electrode that are placed on either side of said medium or the direction of said medium.

Features of the described embodiments include:
the first electrode is covered with a screen coming into contact with the electrode, said screen having a dielectric strength higher than 6 kV/mm, and preferably higher than 9 kV/mm;
the second electrode is covered, directly or indirectly, with a protective layer, said protective layer being secured to this second electrode and having a superficial resistivity higher than 1×10¹²Ω/□, irrespective of the relative humidity level, and in particular beyond 70%.

Thus, the disclosed embodiments include covering each electrode with at least one layer that has complementary properties. This combination allows the formation of a homogeneous electric field between the electrodes, in particular when the amplitude of the electric field is high and/or the relative humidity between the electrodes is high.

In order to make it possible to establish an electric field with a high amplitude between the electrodes, the first electrode is covered with a screen comprising a high dielectric strength, i.e., above 6 kV/mm, or even 9 kV/mm.

The screen in contact with the first electrode can be made from a dielectric material such as glass, quartz, alumina, mullites, steatite, mica, etc.

To improve the homogeneity of the electric field between the electrodes, a protective layer covers the second electrode. It should be recalled that the superficial resistivity corresponds to the surface resistance measured between two electrodes with a length equal to the space between them. Because the superficial resistivity corresponds to a resistance, it is expressed in the same unit as a resistance. However, to avoid any confusion, the unit used is the Ω·cm/cm, or, as in the rest of this Application, in ohms per square, or Ω/□, having recalled that this involves the resistance measured between two opposite sides of a square. Due to its higher electric superficial resistivity, which is greater than 1×10¹²Ω/□, the difference in voltage between the electrodes can be reproduced more faithfully, since the electric charges have more difficulty moving over the surface of the protective layer. They are therefore distributed according to the geometry of the second electrode. It is thus possible to generate a homogeneous electric field between the first and second electrodes more easily, especially when the electric field has a high amplitude.

A limited displacement of the electric charges on the surface of the protective layer has been observed when the latter has a superficial resistivity greater than 1×10¹²Ω/□. Given that the ability to homogenize the electric field depends on the surface resistivity of the protective layer, the thickness of the latter has little influence and can vary from several hundredths to several millimeters.

Another advantage related to the protective layer lies in preserving the integrity of the apparatus for longer by limiting the movement of the electric charges on the surface of the protective layer. The electric charges are therefore less likely to aggregate and promote the formation of electric discharges between said electrodes. “Electric discharges” refer to occasional electric discharges occurring between the electrodes and appearing visually in the form of a more intense luminous filament. These electric discharges have the drawback of electrically and thermally stressing the layers covering the electrodes, by forming hot spots on their surface promoting faster aging of said layers.

The protective layer thus makes it possible to establish a homogeneous electric field in the apparatus, promoting the formation of a homogeneous plasma when the amplitude of the electric field is sufficient to ionize the air between the first and second electrodes. The presence of this plasma is also influenced by different parameters, for example the type of gas, its pressure, the frequency and amplitude of the electric field between the electrodes.

The Applicant has also identified that the surface layer of the electrodes may be subject to occasional temperature increases, due to charge concentrations, created by the presence of singularities in the material to be treated. This may for example involve variations in thickness, or the presence of impurities in the fibrous material subject to the electric field. These temperature increases can be curbed by using materials, in particular for the protective layer, having a good thermal stability, i.e., that retain their structural, and therefore electric, properties beyond a temperature threshold, typically of about 250° C. Of course, the electric properties, in particular dielectric strength, of the characteristic layers must be above a predefined threshold of 6 kV/mm.

Relative to the apparatuses of the prior art, this improved homogeneity of the electric field between the electrodes allows the use of voltages with higher amplitudes advantageously making it possible to perform faster, deeper impregnations, without causing early aging of the layers covering the electrodes, and more particularly the screen covering the first electrode. Indeed, in the apparatuses known in the prior art, in which the electrodes are covered with materials such as glass, or even ceramic, the superficial resistivity is known to drop below 10¹⁰Ω/□, or even 10⁹Ω/□, when the relative humidity level exceeds 70% or 80%.

The protective layer can be formed from polymer materials such as a material belonging to the family of polyimides, polyether ketones, silicones or fluoropolymers. These materials may be used alone, in mixtures or reinforced, and may take the form of a pre-existing film or an overlayer deposited on the second electrode.

The value of the electric field between the first and second electrodes can be comprised between 0.1 and 50 kV/mm, preferably between 0.5 and 30 kV/mm. In this value range, the frequency of the electric field can be comprised between 1 and 1,000 Hz, preferably between 10 and 300 Hz.

Optionally, in order to reinforce the homogeneous nature of the electric field between the first and second electrodes, it is possible to consider covering the screen in contact with the first electrode with a protective layer as described above. In other words, the screen may be covered with a protective layer such that the opposite faces of the screen are in contact with the electrode and the protective layer. The first electrode may therefore be covered with a multilayer comprising a screen and a protective layer.

According to one alternative embodiment, to increase the dielectric strength of the second electrode and thus make it possible to increase the amplitude of the electric field between said electrodes owing to better electric isolation, it is possible to consider inserting a screen as described above between the second electrode and the protective layer. In other words, the second electrode can be covered with a multilayer comprising a screen and a protective layer to form a compact assembly, free of any air knife inside which a highly ionic environment, comparable to a plasma, could form due to residual humidity.

Similarly, to improve the homogeneity of the electric field between the electrodes, a protective layer as described above may cover the screens in contact with the first and second electrodes. In other words, the first and second electrodes may be covered with a same multilayer as described above, and form two stacks of layers mechanically secured to one another, and with no air knife, in order to form a continuous environment free of any air knife, without the possibility of the appearance of gas ionization phenomena within the stack of layers itself.

Optionally, an impregnating apparatus described above may comprise a specific device making it possible to reduce the humidity level between the first and second electrodes. Advantageously, one sees an improvement in the homogeneity of the electric field when the humidity level is reduced in the apparatus. This improvement is notable below 60% relative humidity and becomes significant below 50% relative humidity. It has for example been observed that a homogeneous plasma obtained with a 45% relative humidity level in an apparatus according to the prior art can be obtained with a 65% relative humidity level in an apparatus. The protective layer advantageously makes it possible to establish a homogeneous and stable electric field between the first and second electrodes, even when the level is greater than or equal to 60% relative humidity in the apparatus. However, it will be noted that the apparatuses must be able to operate correctly under a higher humidity, depending on their geographic location, and variations in weather conditions.

In practice, a relative humidity level measurement is preferably done after a length of time allowing the electrodes to reach a stabilized temperature, and for the environment present between the electrodes to be in a stable state regarding the temperature and pressure parameters.

The apparatus may comprise a device for driving the porous medium, allowing said medium to pass between the electrodes of the apparatus. The presence of a protective layer on an electrode of the apparatus makes it possible to generate a more homogeneous electric field between the electrodes when the amplitude of the electric field increases. As a result, the presence time of a porous medium in the apparatus can be reduced by increasing the value of the electric field, without deteriorating the homogeneity of its impregnation. Thus, the treatment times of the porous medium can be reduced to several tens of seconds for the impregnation of hygienic paper or nonwovens, for example, whereas they are currently several seconds. As a result, the movement speed of a porous medium may be higher in an apparatus according to this disclosure than in an apparatus according to the prior art, for an identical or similar impregnation of the porous medium.

Optionally, the apparatus may comprise a device for pre-treating the porous medium before it is introduced between the first and second electrodes, such that said medium has an increased electric resistivity. To that end, the pre-treatment device may incorporate a drying device and/or a heating device making it possible to treat a porous medium before it is inserted into the apparatus, by promoting the discharge and/or evaporation of residual humidity present in said medium. For example, drying a hydrophilic fiber such as cotton makes it possible to increase its electric resistivity, and therefore to limit the risks of the formation of electric discharges between the electrodes, when it is impregnated with a polypropylene powder. Likewise, the passage of a mat made from polyester fibers in a climate-controlled enclosure with a relative humidity level below 40% makes it possible to increase its electric resistivity, which makes it possible to improve the impregnation quality and speed of the mat with epoxide powder, for example.

In general, the apparatus comprises a powder depositing device making it possible to deposit said powder in contact with a porous medium before it passes between the first and second electrodes of the apparatus. The depositing device is preferably arranged between the aforementioned pre-treatment device and the electrodes. However, the configuration of the disclosed embodiments may also be used when the powder is pre-deposited on the surface of the medium before the pre-treatment device.

This application also relates to a method for impregnating a porous medium using an apparatus as described above, which may comprise, before the application of an alternating electric field through the porous medium, a prior step for drying said medium by air drying or heat drying. This step is preferably:
heating when the medium comprises hydrophilic fibers, such as natural or cellulosic fibers;
air drying when the medium comprises hydrophobic fibers, such as synthetic fibers covered with a moisture-sensitive anti-static overspray.

### BRIEF DESCRIPTION OF THE FIGURES

The embodiments will be better understood upon reading the following description, given solely as an indicative and non-limiting example, and with reference to the accompanying figures, in which the same references designate identical or similar elements and in which:

FIG. 1A is a longitudinal view diagram of one example embodiment of an impregnating apparatus;

FIG. 1B is a longitudinal view diagram of another example embodiment of an impregnating apparatus;

FIG. 1C is a longitudinal view diagram of another example embodiment of an impregnating apparatus;

FIG. 1D is a longitudinal view diagram of another example embodiment of an impregnating apparatus;

FIG. 2 shows the variation as a function of time of the temperature of the components in contact with the electrodes of an apparatus according to the prior art and the electrodes of an apparatus illustrated in FIG. 1;

FIG. 3 shows an alternative embodiment of the apparatus illustrated in FIG. 1A;

FIG. 4 shows an alternative embodiment of the apparatus illustrated in FIG. 3;

FIGS. 5A and 5B are longitudinal views of an apparatus generating a plasma, showing the distribution of the plasma between the electrodes, according to the prior art and according to one embodiment, respectively;

FIG. 6 shows an alternative embodiment of the apparatus illustrated in FIG. 4;

FIGS. 7A and 8A are longitudinal views of an apparatus generating a plasma, showing the distribution of the plasma between the electrodes as a function of the humidity level of a porous medium present between said electrodes;

FIGS. 7B and 8B are top views of the porous mediums shown in FIGS. 7A and 8A, respectively, after they have passed between the electrodes and been impregnated with powder.

### DETAILED DESCRIPTION

As a reminder, this application aims to propose an apparatus for impregnating a porous medium with powder, having better resistance to aging and allowing the formation of a more homogeneous electric field to promote more regular impregnation of the powder in the porous medium.

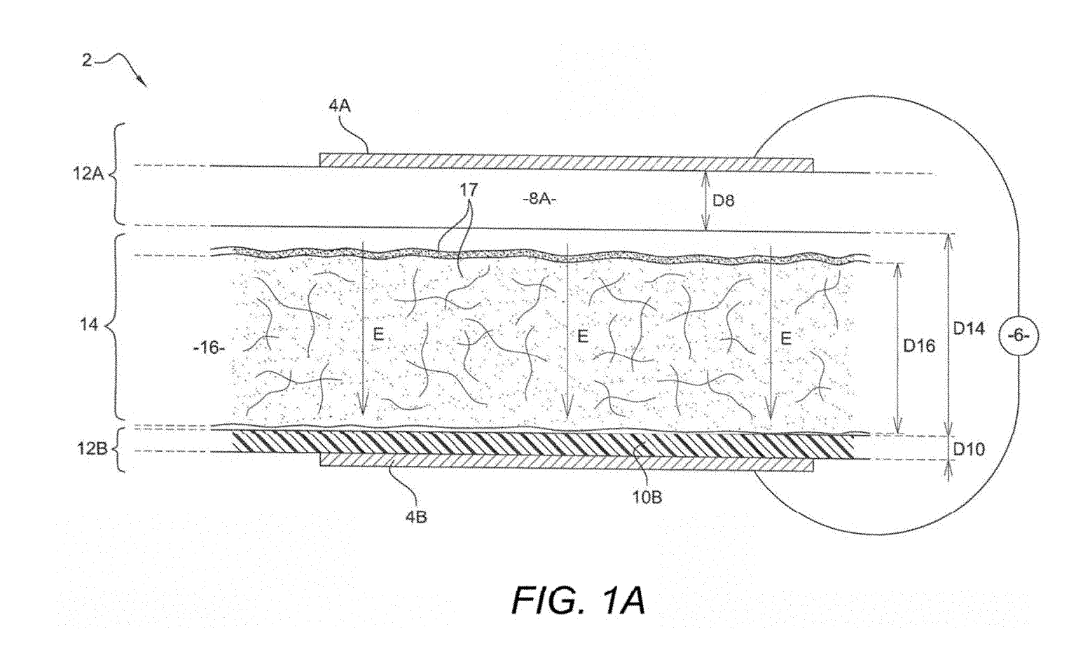

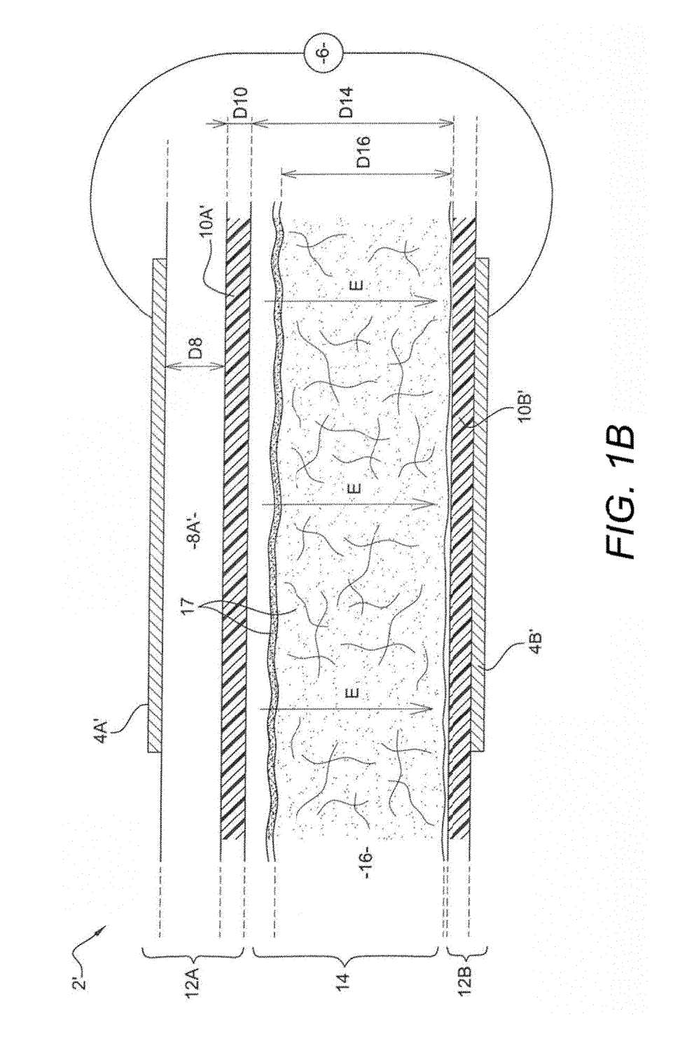

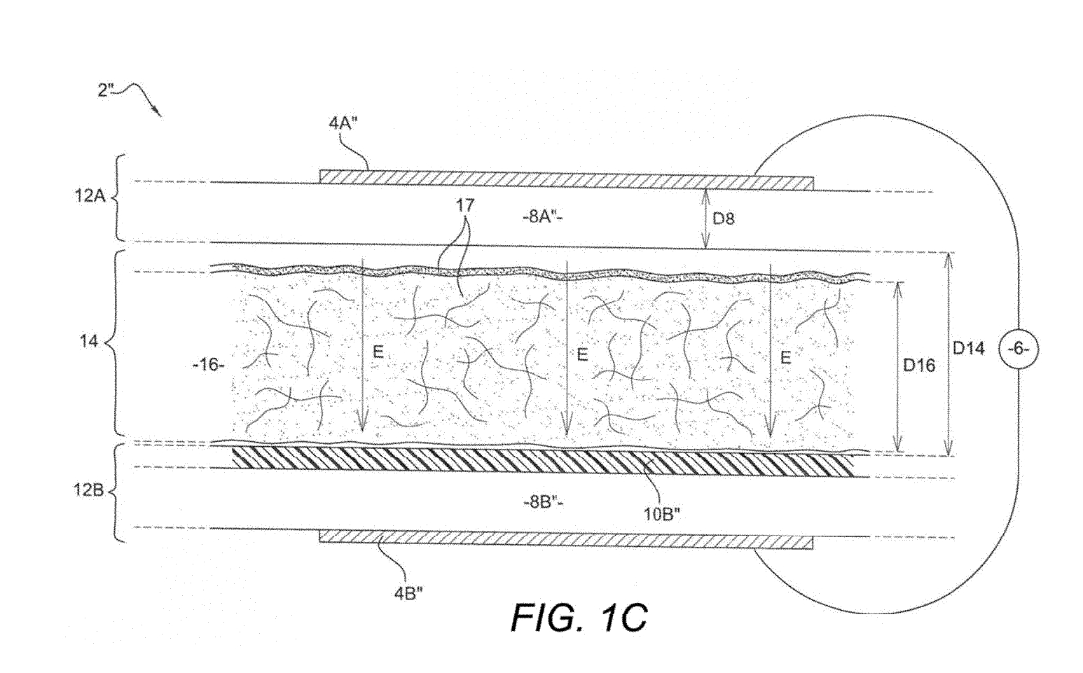

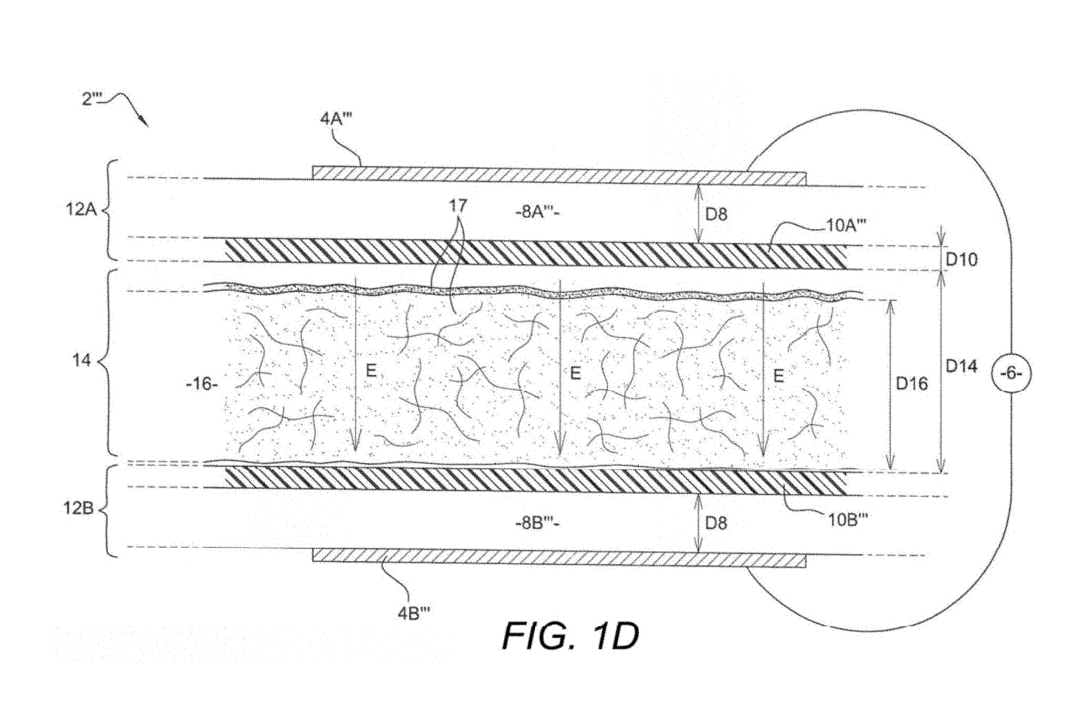

One example embodiment of an impregnating apparatus 2 is shown schematically in FIG. 1A. According to this example, the apparatus includes two electrodes 4A and 4B facing and substantially parallel to one another. A first electrode 4A is in contact with a screen 8A characterized by a dielectric strength greater than 6 kV/mm.

The screen 8A makes it possible to electrically isolate the electrodes from one another. The thickness D8 of the screen can be adapted to support the electrode 4A. To that end, its thickness may be comprised between 1 and 20 mm. In this case, the screen 8A is a quartz plate whose thickness is equal to 5 mm.

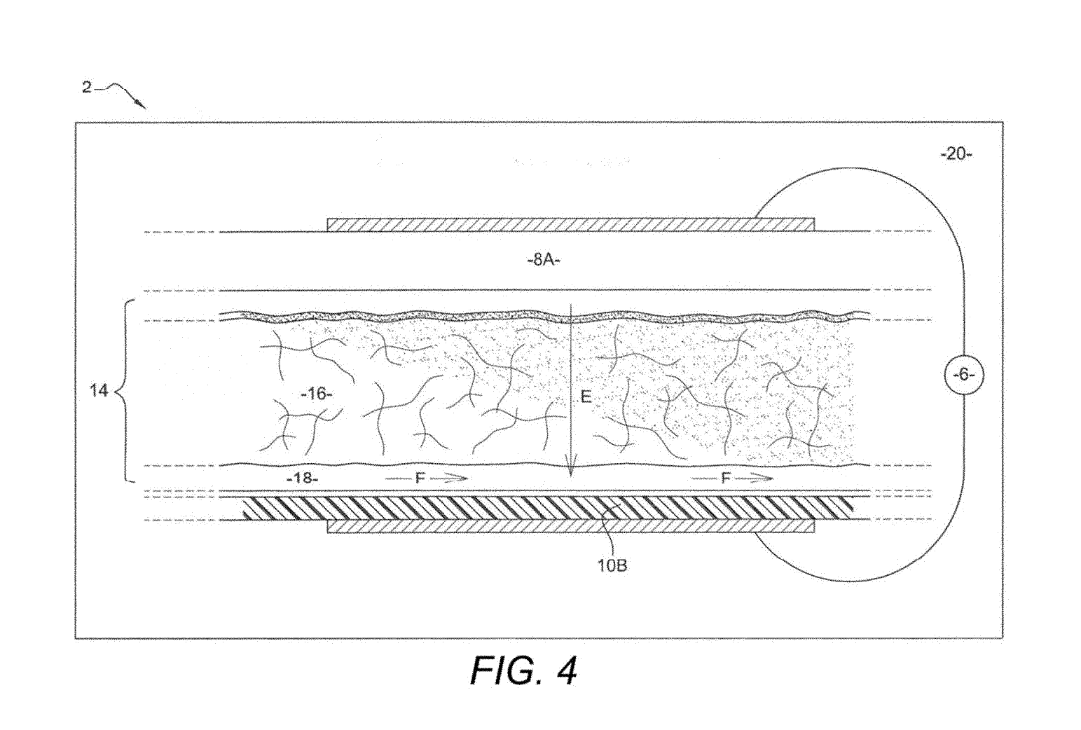

A second electrode 4B of the apparatus is covered with a protective layer 10B characterized by an electric superficial resistivity greater than 1×10¹²Ω/□. The electric superficial resistivity or surface resistivity characterizes the capacity of a material to slow the circulation of a current on its surface in the presence of a difference in voltage. The electric superficial resistivity is measured according to standard “ASTM D 257-99” by using concentric electrodes described in FIG. 4 of the standard. The value of the electric superficial resistivity is expressed in Ohm or Ohm/□ to indicate whether it involves a surface resistivity. In other words, a surface having a high surface resistivity is characterized by a low mobility of the electrons on its surface.

The protective layer 10B in contact with the second electrode 4B therefore advantageously makes it possible to limit the movement of the electric charges on its surface, so as locally to avoid concentrations of charges that could form spots with high voltage promoting the establishment of electric discharges between the electrodes 4A and 4B. As a result, the electric charges present on its surface have greater difficulties in aggregating to form local spots with high voltage, relative to the electric charges present on the surface of a quartz screen, for example.

The thickness D10 of the protective layer 10B can be comprised between several hundredths and several millimeters. According to this example, the protective layer is made from silicone, the thickness of which is equal to about 1 mm.

The electrodes 4A and 4B are arranged so as to define a passage 14 for a porous medium 16. The apparatus may comprise an adjustable device of the rack or other type (not shown in the figures), making it possible to control the distance D14 separating the protective layers. This distance may be comprised between 1 and 50 mm. In the example considered here, the distance D14 is equal to 15 mm.

The electrodes 4A and 4B are preferably uniform conducting plates, so as to promote the establishment of a homogeneous electric field between them. These conducting electrodes can for example be made up of copper or aluminum plates, vacuum metal depositions, silver lacquer or any other appropriate conductors.

The contemplated embodiments are not limited to a particular form and arrangement of electrodes. The electrodes can be solid or openworked, and have multiple forms, such as concave or convex or tubular, and optionally comprise several conducting elements connected to one another. For example, embodiments may comprise discontinuous electrodes made up of a range of conductive strips, as described in document FR 2,933,327 on pages 5 and 6.

According to another embodiment not shown in the figures, the first electrode and/or the second electrode can be replaced by a series of tubular electrodes with different sections, making it possible to apply an electric field through a porous medium passing between said electrodes. In this case, a first series of electrodes can be covered with a screen having a dielectric strength greater than 6 kV/mm, and the second series of electrodes can be covered with a protective layer having a superficial resistivity greater than 1×10¹²Ω/□. Like for FIGS. 1A to 1D, the first series of electrodes may optionally have, in addition to its screen, a protective layer having a superficial resistivity greater than 1×10¹²Ω/□, and the second series of electrodes may have a screen inserted between the electrodes and the protective layer, the screen having a dielectric strength greater than 6 kV/mm. The first and second series of electrodes may be inverted.

According to another embodiment not shown in the figures, the first electrode 4A may be cylindrical and pivot around its axis of revolution, the second electrode 4B may be made up of several tubular electrodes comprising a glass screen with a rectangular section, inwardly metalized, and positioned across from the first electrode 4A. The cylinder making up the first electrode 4A is covered with a layer of silicone serving as a protective layer 10A. The protective layer and/or the glass screen may have asperities or a relief on their surface so as to be able to store powder temporarily before releasing said powder into a space formed between the first and second electrodes 4A and 4B.

To allow the generation of an electric field E between the electrodes, they are connected to a same alternating voltage generator 6, able to deliver a voltage comprised between 1 and 100 kV, at a frequency comprised between 1 and 1,000 Hz.

FIG. 1B illustrates another embodiment of an impregnating apparatus 2′, including two electrodes 4A′ and 4B′ facing and substantially parallel to one another. A first electrode 4A′ is in contact with a screen 8A′ with characteristics similar to the screen 8A described above. A second electrode 4B′ and the screen 8A′ are respectively covered with a protective layer 10B′ and a protective layer 10A′. The protective layers are similar to the protective layer 10B. Advantageously, a protective layer is deposited on each electrode to strengthen the homogeneity of the electric field generated between said electrodes.

FIG. 1C illustrates another embodiment of an impregnating apparatus 2″, including two electrodes 4A″ and 4B″ facing and substantially parallel to one another. A first electrode 4A″ and a second electrode 4B″ are respectively in contact with a screen 8A″ and 8B″ with characteristics similar to the screen 8A described above. The screen 8B″ in contact with the second electrode 4B″ is covered with a protective layer 10B″ similar to the protective layer 10B. Advantageously, the screens 8A″ and 8B″ in contact with each electrode make it possible to generate, between said electrodes, an electric field with a higher amplitude relative to the impregnating apparatus 2′ shown in FIG. 1B.

FIG. 1D illustrates another embodiment of an impregnating apparatus 2′″, including two electrodes 4A′″ and 4B′″ facing and substantially parallel to one another. Each electrode is in contact with a screen 8A′″ and 8B′″, the screens respectively being covered with a protective layer 10A′″ and 10B′″. The screens and the protective layers have characteristics similar to those described above. According to this example embodiment, each electrode is in contact with a screen so as to improve the electric isolation between said electrodes to make it possible to increase the amplitude of the electric field between the electrodes. These two screens are each covered with a protective layer 10A′″ and 10B′″ to make it possible to homogenize the electric field between the electrodes 4A′″ and 4B′″.

The porous medium 16 passing between the electrodes making up the apparatuses described above may for example be an array of synthetic and/or natural fibers, a nonwoven or woven, paper, or even open-cell foam. The porous medium may for example be a needled mat made up of polyester or natural fibers such as cotton, hemp, wool or the like.

The powder 17 impregnating the porous medium 16 may be a powder of the thermoplastic or thermosetting type, such as a polyamide powder or an epoxide powder. The term “powder” may designate a mixture of powders of different types and with different particle sizes.

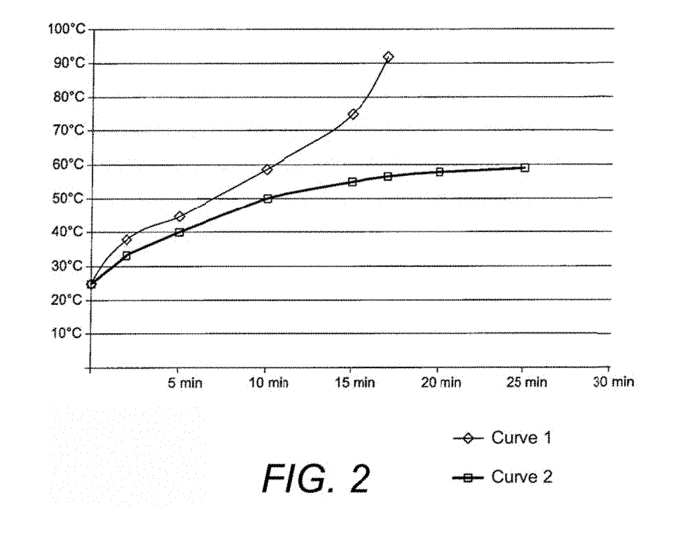

FIG. 2 illustrates an advantage related to the use of the protective layers described above in an impregnating apparatus. More specifically, FIG. 2 shows temperature variation curves measured on screens of an apparatus according to the prior art not including protective layers, and an apparatus illustrated in FIG. 1D. Of course, the temperature measurements are done under the same usage conditions and the same arrangements for both types of apparatus. More specifically, the panes of glass in contact with the electrodes have a thickness of 3 mm and are spaced apart by a distance of 20 mm. A voltage of 45 kV at 50 Hz is applied between the electrodes. FIG. 2 shows a sudden increase in the temperature of the glass screens after 15 minutes of use of the apparatus when they are not covered with protective layers as described above (curve 1), up to a temperature above 90° C., where the breakdown of said screens is observed. Conversely, when the glass screens 8A′″ and 8B′″ are respectively covered with a protective layer 10A′″ and 10B′″, the temperature of the glass screens does not exceed 60° C. (curve 2), and no electric discharge is observed between the electrodes 4A′″ and 4B′″. The protective layers therefore make it possible to limit the breakdown risk of the apparatus over time. More specifically, the greater the resistivity of the protective layers is, the lower this risk is, such that the apparatus has better resistance to aging.

Another advantage related to the electric superficial resistivity value of the protective layers lies in allowing the establishment of a more homogeneous electric field E in the passage 14 formed between the first and second electrodes of the apparatus. Indeed, the electric field is more faithful to the arrangement of the electrodes, since the electric charges created by the electrodes move only slightly on the surface of the protective layer(s). Thus, the distribution of the charges generated for example on the surface of the electrode 4B in FIG. 1A is substantially the same at the surface of the protective layer 10B defining the passage 14. The impregnation of a porous material can thus be better controlled.

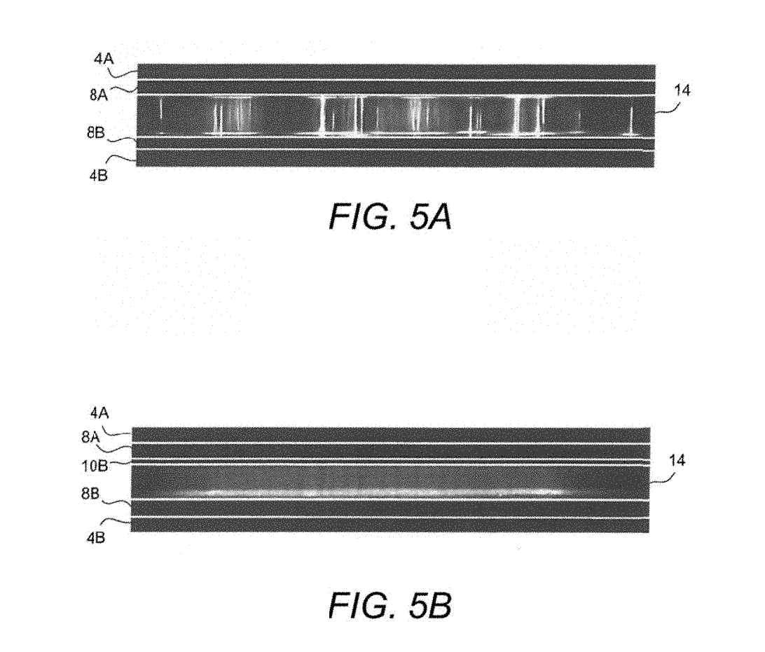

As shown in FIG. 5B, an electric field of 4 kV/mm is generated that is more homogeneous between the first and second electrodes in the configuration of FIG. 1C, compared to a configuration of the prior art, in which the electrodes are only covered with a dielectric screen of the glass layer type, as illustrated in FIG. 5A. One can in fact see that between the electrodes, fewer electric discharges form, embodied by the light vertical strips in FIG. 5B corresponding to the configuration of the described embodiments, relative to FIG. 5A illustrating the prior art. FIGS. 5A and 5B have been done for configurations with the following parameters:
metal electrodes 4A, 4B which are 5 mm thick;
dielectric screen layer 8A, 8B made from glass 5 mm thick;
protective layer 10B made from polytetrafluoroethylene (PTFE) 2 mm thick (present only in FIG. 5B);
air knife 14 between the faces of the electrodes: 10 mm;
electric field applied between the electrodes: 4 kV/mm AC sinusoidal at 50 Hz;
relative ambient humidity: 75%;
room temperature: 19° C.

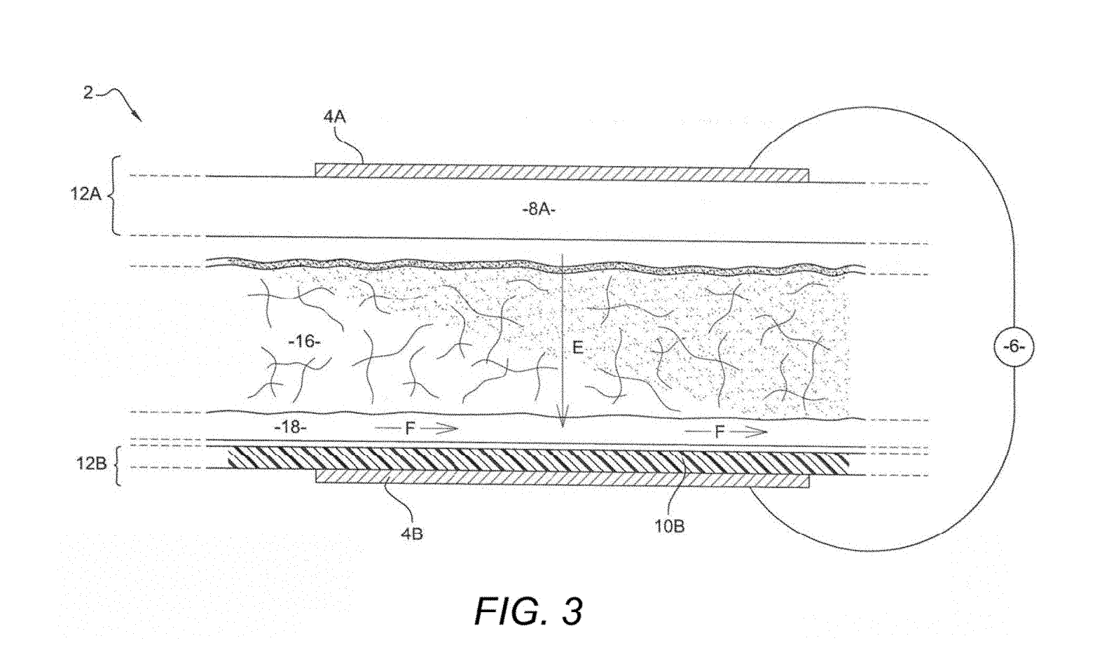

According to one alternative of an impregnating apparatus 2 as shown in FIG. 1A, the apparatus may comprise a driving device 18 for driving the porous medium 16 as illustrated in FIG. 3. For example, this device may comprise a belt conveyor on which a porous medium can be deposited, so as to allow said medium to pass between the electrodes in the direction of advance F. The driving device may for example move the porous medium at speeds comprised between 20 and 500 m/min, which are higher than the impregnating speeds of the prior art.

According to an alternative of the apparatus shown in FIG. 3, the impregnating apparatus may include a specific device 20 known in the prior art as shown in FIG. 4, of the confinement chamber type, making it possible to monitor the characteristics of the gas present in the passage 14. The specific device may for example control the relative humidity level and keep it between 30% and 60%, preferably between 30% and 50%.

The composition of the gas in the passage 14 may also be controlled by the specific device 20 and for example comprise one of the following gases: argon, nitrogen, oxygen. The pressure of the gas may also be set by said device in a value range comprised between 10⁻⁷ and 1,000 hPa (10⁻⁷ and 1,000 mbar), preferably between 10⁻³ and 1,000 hPa (10⁻³ and 1,000 mbar).

It should also be noted that depending on the amplitude and application time conditions of the electric field and the gas present in the passage 14, the presence of a plasma may cause changes to the surface tension of the materials present between the first and second electrodes (physiochemical change of the materials). This change in surface tensions may for example make it possible to increase the hydrophilic or hydrophobic nature of a material.

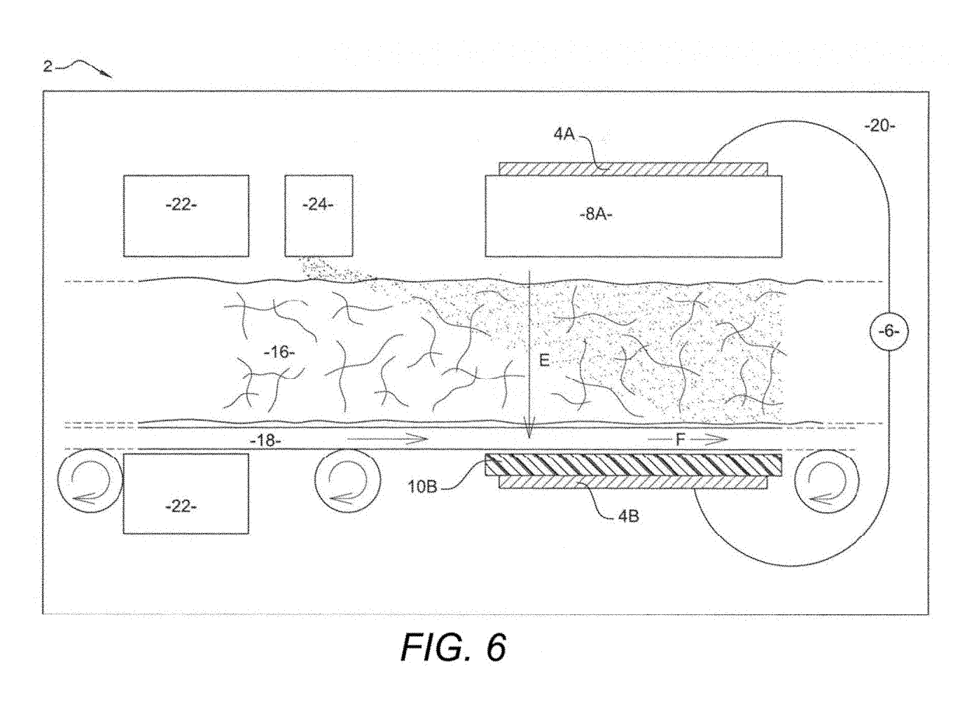

According to one alternative of the apparatus shown in FIG. 6, the impregnating apparatus 2 may comprise a pre-treatment device 22 making it possible to prepare the porous medium 16 before it is impregnated. The pre-treatment device may prepare the porous medium so as to control the value of its volume resistivity at a value above 10⁹ Ω·cm, to promote the establishment of a homogeneous electric field between the electrodes. For example, the pre-treatment device can preheat the porous medium to lower its humidity level and/or to diffuse dry air through the porous medium. It is also possible to consider heating the electrodes in order to raise the superficial resistivity value.

The impregnating apparatus may comprise a device 24 for depositing powder 17 making it possible to deposit the powder in contact with the porous medium 16 before it passes between the electrodes 4A and 4B. The depositing device is preferably arranged between the aforementioned pre-treatment device and the electrodes.

This application also relates to a method for impregnating a porous medium with powder, consisting of applying an electric field comprised between 0.1 and 50 kV/mm to a porous medium 16 covered with powder 17.

The porous medium 16 may be a fibrous array, for example a nonwoven or woven, paper, or open-cell foam.

The powder can incorporate different components in terms of chemical composition or particle size, and additives or other complementary compounds intended to impart specific properties to the powder.

The impregnating method can comprise a preliminary step for pre-treating the porous medium 16 by heating or drying by blowing dry air through the medium, to make it possible to limit the attenuation of the electric field traversing said medium. This step can consist of lowering the humidity level of the medium when one of these components is known to have a certain humidity absorption level such as natural fibers, polyamide or moisture-sensitive anti-static oversprays. This heating and/or drying step advantageously makes it possible to increase the volume resistivity of the porous medium so as to disrupt the electric field as little as possible, to promote homogeneous impregnating of the powder in the porous medium. For example, to increase the volume resistivity of natural fibers making up the medium to a value above 10⁹ Ω·cm, the medium may be dried beforehand. In the case where the medium includes synthetic fibers covered beforehand with an overspray, having anti-static characteristics in the presence of moisture in the air, a pre-treatment with dry air makes it possible to increase its volume resistivity above 1×10⁹ Ω·cm.

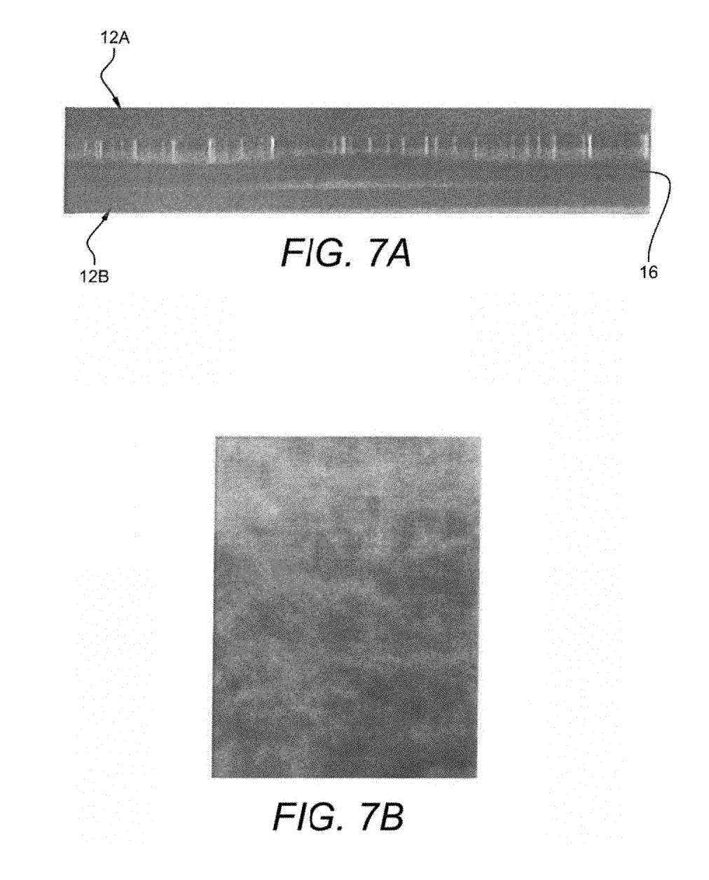

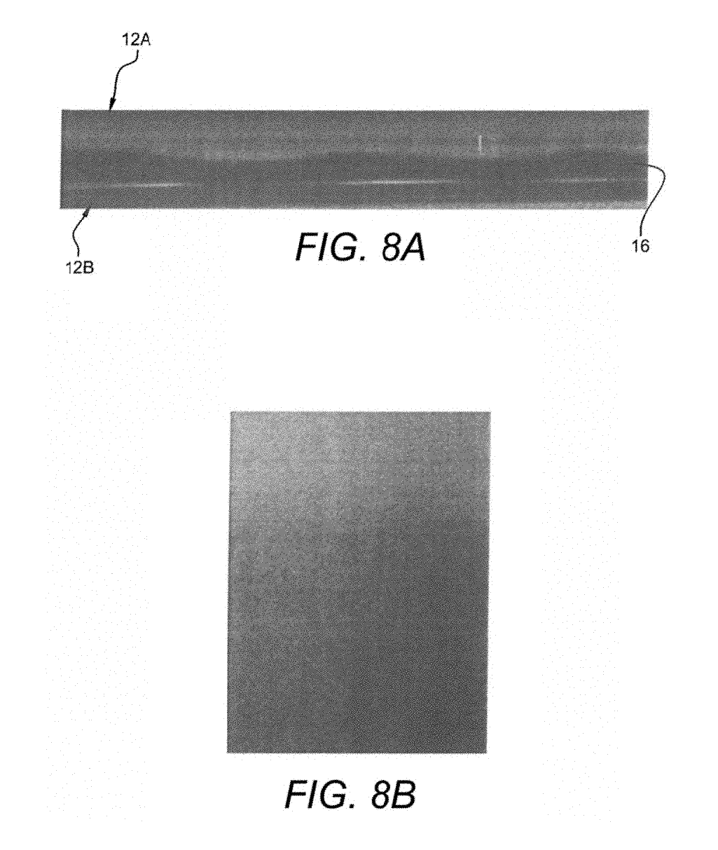

FIGS. 7A and 8A respectively illustrate the distribution of an electric field encompassing a porous medium 16 with a relative humidity level of about 70% at 20° C. and a similar medium conditioned so that its level is equal to 32% relative humidity at 21° C. FIG. 8A shows a more homogeneous distribution of the electric field around the pre-conditioned medium relative to FIG. 7A. As shown by FIGS. 7B and 8B illustrating the distribution of the powder above the medium of FIGS. 7A and 8A, respectively, the powder is impregnated more homogeneously in the medium 16 when its humidity level is reduced.

Of course, the impregnating methods described here may be implemented by one or several impregnating apparatuses 2, 2′, 2″, 2′″ described above.

In conclusion, this application proposes an apparatus for impregnating a porous medium using an electric field. The apparatus advantageously comprises one or two protective layers, as well as one or two dielectric screens protecting the electrodes of the apparatus. The protective layers limit the movement of the electric charges on their surface, thus enabling precise control of the distribution of the electric field between said layers over space and time. As a result, the electric phenomena deteriorating the apparatus, such as the formation of electric discharges between the electrodes, are limited. The apparatus thus holds up better over time. The contemplated embodiments also allow the formation of a more homogeneous electric field between the electrodes so as to promote a more regular impregnation of a porous medium covered with powder passing between said electrodes.

1. An apparatus for impregnating a porous medium with powder, including a device able to generate an alternating electric field through the porous medium, the device including a first electrode and a second electrode which are placed on either side of the porous medium, wherein:
the first electrode is covered with a screen coming into contact with the electrode, said screen having a dielectric strength higher than 6 kV/mm, and preferably higher than 9 kV/mm;
the second electrode is covered with a protective layer, said protective layer being secured to the second electrode and having a superficial resistivity higher than 1×10¹²Ω/□, irrespective of the relative humidity level.

2. The apparatus according to claim 1, wherein the protective layer has a structural stability above 250° C.

3. The apparatus according to claim 1, wherein the screen in contact with the first electrode is covered with a protective layer coming into contact with the screen, said protective layer having a superficial resistivity above 1×10¹²Ω/□.

4. The apparatus according to claim 1, that wherein a screen is inserted between the second electrode and the protective layer, said screen having a dielectric strength greater than 6 kV/mm.

5. The apparatus according to claim 4, wherein the screen is covered with a protective layer, said protective layer having a superficial resistivity above 1×10¹²Ω/□.

6. The apparatus according to claim 1, wherein the electric field generated between said electrodes is comprised between 0.1 and 50 kV/mm.

7. The apparatus according to claim 1, wherein a specific device keeps the relative humidity level at less than 60% between said electrodes, when the electrodes are powered on.

8. The apparatus according to claim 1, further comprising a driving device for driving the porous medium between said electrodes.

9. A method for impregnating a porous medium, the method comprising:
introducing the porous medium into an impregnating apparatus;
heating the porous medium prior to the application of an electric field,
wherein the impregnating apparatus includes: (i) a device able to generate the electric field through the porous medium, and (ii) a first electrode and a second electrode which are placed on either side of the porous medium,
and wherein the first electrode is covered with a screen coming into contact with the electrode, said screen having a dielectric strength higher than 6 kV/mm, and preferably higher than 9 kV/mm;
and wherein the second electrode is covered with a protective layer, said protective layer being secured to the second electrode and having a superficial resistivity higher than 1×10¹²Ω/□, irrespective of the relative humidity level.

10. A method for impregnating a porous medium, the method comprising:
introducing the porous medium into an impregnating apparatus;
drying the porous medium with dry air prior to the application of an electric field,
wherein the impregnating apparatus includes: (i) a device able to generate the electric field through the porous medium, and (ii) a first electrode and a second electrode which are placed on either side of the porous medium,
and wherein the first electrode is covered with a screen coming into contact with the electrode, said screen having a dielectric strength higher than 6 kV/mm, and preferably higher than 9 kV/mm;
and wherein the second electrode is covered with a protective layer, said protective layer being secured to the second electrode and having a superficial resistivity higher than 1×10¹²Ω/□, irrespective of the relative humidity level.
